(19) United States
(12) Patent Application Publication
(10) Pub. No.: US 2008/0183445 A1
(43) Pub. Date: Jul. 31, 2008

(54) System and method for providing sparkline related information to a user

(76) Inventor: Nicolas Bissantz, Nurnberg (DE)

Correspondence Address: DILWORTH & BARRESE, LLP, 333 EARLE OVINGTON BLVD., SUITE 702, UNIONDALE, NY, 11553, US

(21) Appl. No.: 11/699,255

(22) Filed: Jan. 29, 2007

(51) Int. Cl. G06F 17/18

(52) U.S. Cl. 703/2

(57) ABSTRACT

The present invention relates to a system for providing information to a user, said system comprising means for representing a sparkling which is composed of one or more than one graphical element which is/are based on two or more than two values, wherein the system further comprises trend-determining means for determining whether said one or more graphical elements or said two or more than two values exhibit a trend as well as means for representing said trend. The present invention further relates to a method for providing information to a user.

### BACKGROUND OF THE INVENTION

The present invention relates to a system and to a method for providing information related to a sparkline to a user.

In order to display a large amount of numerical information in a compact and intelligible form it is known from the prior art to use so-called sparklines which are word-sized, miniaturized diagrams. Sparklines provide information in small spaces.

For example, exchange rate movements, sports results, temperature variation etc. may easily be illustrated by use of such word-sized graphics. Sparklines, for example, consist of a column diagram and/or bar diagram and/or line diagram in which the respective columns/bars/lines represent values, as, for example, turnover values for different months.

### SUMMARY OF THE INVENTION

It is the object of the present invention to provide a system and a method for improving the user's perception of the information related to a sparkline.

This object is solved by a system as well as a method with the features herein.

The system according to the present invention comprises representing means for representing a sparkline which is composed of one or more than one graphical element, for example of a line or of two or more than two columns or bars, which are based on two or more than two values, wherein the system further comprises trend-determining means for determining whether said one or more graphical elements or said two or more than two values exhibit a trend as well as means for representing this trend.

According to the present invention the intelligibility of a sparkline is increased by representing a trend which gives the information to the user whether or not the sparkline or the values on which the sparkline is based, respectively, exhibit a trend or not. The term “trend” refers to any development of a first variable (such as turnover, sales numbers etc.) with respect to a second variable (such as time, area, age etc.). Accordingly, the term “trend” is not limited to the dependency of a variable over time, i.e. to a chronological development of said variable. However, such chronological trends are of course also covered by the present invention.

The means for representing a sparkline and/or the means for representing a trend may for example be means for displaying the sparkline on a screen. However, it is also possible to represent the sparkline and/or the trend by any other suitable means, such as for example in a printed manner. The term “representing” encompasses any kind of perception of the sparkline and/or the trend by a user.

It is, for example, conceivable that the means for representing the trend are adapted to represent a character, number or any symbol such as a line or arrow, wherein the inclination of the line or arrow is representative for the magnitude of the trend which has been determined by said determining means.

If for example the trend of the values on the basis of which the sparkline is created is pronounced—for example a high increase of a variable over time—the line or arrow will exhibit a higher inclination as in case of a less pronounced trend. Accordingly, in this embodiment of the invention the inclination of the trend, i.e. for example the inclination of a regression line, is determined and mapped onto the inclination of the line or arrow or any other suitable trend-symbol which is represented for example on the screen. It is conceivable that if no trend is determined the line or arrow is represented horizontally or that no line or arrow or other symbol or that a certain symbol, indicating that no trend exists, is represented.

Alternatively, it is conceivable, that the line or arrow which is represented as trend information for example on the screen may only be represented in a limited number of predetermined slopes such as with one positive slope, indicating a positive trend, with no slope, indicating no trend, and with one negative slope, indicating a negative trend.

The means for representing the trend may be adapted to represent the trend adjacent to the sparkline to which it refers. In accordance with a further embodiment of the invention the means for representing the trend is adapted to represent the trend besides, below or above the sparkline.

In accordance to a further embodiment of the present invention the trend-determining means are adapted to perform a regression analysis in order to determine a trend, wherein the regression analysis is based on the one or more graphical elements or based on the two or more than two values on which the one or more than one graphical elements are based. For example, a linear regression may be performed by using the so-called least square's method. However, the present invention is not limited to a linear regression and includes any other technique (non-linear regression etc.) which is suitable for the purpose of determining a trend information.

In order to further increase the information content of the trend information, the system in accordance to the present invention may further be adapted to determine the quality of the regression or any other technique for determining a trend information. In accordance with a non-limiting example, said trend-determining means may be adapted to determine the coefficient of determination R². R² is called “goodness of fit” and is the proportion of variability in a data set that is accounted for by a statistical model. Specifically, R² is an element between 0 and 1 and represents the proportion of variability in a dependent variable that may be attributed to the influence of an independent variable on said dependent variable.

Further, the trend-determining means may be adapted to determining the significance of the coefficient of determination. This determination may be performed by the so-called F-test which is used for the assessment whether or not the coefficient of determination is accidental or not. However, the present invention is not limited to the F-test and includes any other suitable means and method for determining the significance of the coefficient of determination.

In accordance to a further embodiment of the present invention said trend-determining means are adapted to determine that no trend exists when the coefficient of determination is below a predetermined value.

The present invention further relates to a method for providing information to a user, said method comprising representing a sparkline which is composed of one or more than one graphical element which is/are based on two or more than two values, wherein the method further comprises determining whether said one or more graphical elements or said two or more than two values exhibit a trend as well as representing this trend.

The sparkline and/or the trend may be represented for example on a screen or in any other kind, such as for example on a printed matter or as printout.

The method, for example, may comprise the step of representing the trend as line or arrow or as any other symbol, character or number, wherein the inclination of the line or an arrow represents the magnitude of the determined trend. If for example a regression line is determined it is conceivable to acquire the inclination of the regression line and to base the inclination of the line or arrow or the kind of symbol on the acquired inclination of the regression line.

Further, the trend may be represented adjacent to the sparkline to which it refers. The trend may for example be represented besides, below or above the sparkline.

In accordance to a further embodiment of the present invention the method comprises performing a regression analysis in order to determine a trend, wherein the regression analysis is based on the one or more graphical elements or based on the two or more than two values on which the one or more than one graphical elements are based. In order to provide a regression line which represents a correlation between a dependent variable (for example turnover) and an independent variable (for example time) for example the method of least squares may be employed. However, the present invention is not limited to the method of least squares and includes any other suitable method for obtaining a regression line.

The method may further comprise the determination of the quality of the regression and in particular may include the determination of the coefficient of determination R² (goodness of fit). Further, it is conceivable that the method in addition includes means to determine the significance of the coefficient of determination in order to determine whether or not the value for R² is accidental or whether a significant relation between the variables exists. The method may further comprise the step of determining that no trend exists when the coefficient of determination is below a predetermined value.

### DESCRIPTION OF THE PREFERRED EMBODIMENTS

Further advantages and embodiments of the present invention are explained on the basis of the following exemplary embodiment of the invention.

In this embodiment of the present invention a sparkline is displayed to the user on the display of a personal computer or any kind of handheld device, such as a mobile phone. The sparkline may for example be composed of several columns, i.e. vertical bars, which are based on values, for example turnover values vs. time or time period. The higher the column the higher is the value represented by the column. Of course, the present invention is not limited to this example and the spark-line may represent any other information which is conceivable, for example, wins/losses, results of sporting events, sales numbers etc. Further, the invention is of course not limited to a certain kind of sparkline such as a sparkline being composed of a number of columns.

In accordance to the present embodiment in an area besides the sparkline the user is provided with trend information which represents a trend of the values on the basis of which the sparkline is created. This displayed trend information may have the form of an arrow which may be horizontal or which may be inclined by a positive angle if the trend is positive, i.e. the values are increasing or by a negative angle, if the trend is negative i.e. the values are decreasing. If no trend exists the arrow is horizontal or no symbol is represented or a symbol is displayed which indicates that no trend exists.

The trend information is created by a trend-determining means. In accordance with this embodiment of the invention the trend determining means first of all creates a regression line based on the values underlying the sparkline which optimally represents the relationship between a dependent variable and an independent variable. The regression line is created by use of the least-squares method or by use of any other suitable method.

Thereafter, the quality of the regression is determined. For this purpose the trend-determining means determines the coefficient of determination R². Generally, the closer the coefficient of determination is to the value 1 the higher is the quality of the regression. If the coefficient of determination is 0 it is assumed that there is no relationship between the considered variables.

Thereafter, in each case or alternatively only in case of a small coefficient of determination the system determines the significance of the coefficient of determination. This determination is performed by using the so-called F-test and based on this test it is assessed whether or not there is a significant trend. If the F-test exhibits that no significant trend exists, the displaying means of the system in accordance to the present invention displays no or a horizontal arrow indicating to the user that no significant trend exists on the displayed data.

If, however, a trend exists the magnitude of the trend is determined based on the regression line which has been determined in the regression analysis. The inclination of this regression line is representative for the inclination of the trend-arrow which is displayed on the screen to the user. Thus the higher the inclination of the regression line the higher is the inclination of the symbol representing the trend. Alternatively the system is provided with a limited number of symbols, such as for example one symbol representing a positive trend, one symbol representing a negative trend and one symbol representing no trend.

It is conceivable that for each inclination or range of inclinations of the regression line a certain symbol having a certain font is used.

It is further conceivable that the user has the option to select a number of values on the basis of which the sparkline is created or to select a portion of a sparkline and that based upon this selection the determination of the trend is performed. Thus, the user may select only data of particular importance such as for example the turnover-values of the three preceding months for the trend assessment.

1. System for providing information to a user, said system comprising means for representing a sparkline which is composed of one or more than one graphical element which is/are based on two or more than two values, wherein the system further comprises trend-determining means for determining whether said one or more graphical elements or said two or more than two values exhibit a trend as well as means for representing said trend.

2. System for providing information to a user according to claim 1, wherein the means for representing a sparkline are means for displaying the sparkline on a screen.

3. System for providing information to a user according to claim 1, wherein the means for representing a trend are means for displaying the trend on the screen.

4. System for providing information to a user according to claim 1, wherein the means for representing the trend are adapted to represent the trend in the form of a number, character or symbol.

5. System for providing information to a user according to claim 4, wherein the symbol is a line or an arrow, wherein the inclination of the line or of the arrow is representative for the magnitude of the trend which has been determined by said trend-determining means.

6. System for providing information to a user according to claim 1, wherein the means for representing the trend is adapted to represent the trend adjacent to the sparkline to which it refers.

7. System for providing information to a user according to claim 1, wherein the means for representing the trend is adapted to represent the trend besides, below or above the sparkline to which it refers.

8. System for providing information to a user according to claim 1, wherein said trend-determining means are adapted to perform a regression analysis in order to determine a trend, wherein the regression analysis is based on the one or more graphical elements or based on the two or more than two values on which the one or more than one graphical elements are based.

9. System according to claim 8, wherein the regression analysis comprises the method of least squares.

10. System for providing information to a user according to claim 8, wherein said trend-determining means are adapted to determine the quality of the regression.

11. System for providing information to a user according to claim 10, wherein said trend-determining means are adapted to determine the coefficient of determination R² (goodness of fit).

12. System for providing information to a user according to claim 11, wherein said trend-determining means are adapted to determine the significance of the coefficient of determination.

13. System for providing information to a user according to claim 11, wherein said trend-determining means are adapted to assess that no trend exists when the coefficient of determination is below a predetermined value.

14. System for providing information to a user according to claim 12, wherein the systems comprises means which are adapted to determine the significance of the coefficient of determination by using the F-test.

15. Method for providing information to a user, said method comprising representing a sparkline which is composed of one or more than one graphical element which is/are based on two or more than two values, wherein the method further comprises the steps of determining whether said one or more graphical elements or said two or more than two values exhibit a trend as well as representing this trend.

16. Method for providing information to a user according to claim 15, wherein the sparkline is displayed on a screen.

17. Method for providing information to a user according to claim 15, wherein the trend is displayed on a screen.

18. Method for providing information to a user according to claim 15, wherein the trend is represented on the screen as a number, character or symbol.

19. Method for providing information to a user according to claim 18, wherein the symbol is a line or arrow and wherein the inclination of the line or arrow is representative for the magnitude of the determined trend.

20. Method for providing information to a user according to claim 15, wherein the trend is represented adjacent to the sparkline to which it refers.

21. Method for providing information to a user according to claim 15, wherein the trend is represented besides, below or above the sparkline to which it refers.

22. Method for providing information to a user according to claim 15, wherein the method further comprises the step of performing a regression analysis in order to determine a trend, wherein the regression analysis is based on the one or more graphical elements or based on the two or more than two values on which the one or more than one graphical elements are based.

23. Method for providing information to a user according to claim 22, wherein the regression analysis comprises the method of least squares.

24. Method for providing information to a user according to claim 22, wherein the method further comprises the step of determination of the quality of the regression.

25. Method for providing information to a user according to claim 24, wherein said determination of the quality of the regression includes the determination of the coefficient of determination R² (goodness of fit).

26. Method for providing information to a user according to claim 25, wherein the method further comprises the step of determination of the significance of the coefficient of determination.

27. Method for providing information to a user according to claim 25, wherein it is assessed that no trend exists when the coefficient of determination is below a predetermined value.

28. Method for providing information to a user according to claim 26, wherein the significance of the coefficient of determination is performed by using F-test.
